(19) United States
(12) Patent Application Publication
(10) Pub. No.: US 2012/0254330 A1
(43) Pub. Date: Oct. 4, 2012

(54) OPERATION METHOD APPLICABLE TO ELECTRONIC DEVICE WITH OPERATION SYSTEM

(75) Inventors: Lin-Yuan You, Taipei City (TW); Pen-Li Chu, Taipei City (TW)

(73) Assignee: BENQ CORPORATION, Taipei (TW)

(21) Appl. No.: 13/430,866

(22) Filed: Mar. 27, 2012

(30) Foreign Application Priority Data
Apr. 1, 2011 (TW) 100111660

(51) Int. Cl. G06F 15/16

(52) U.S. Cl. 709/206; 709/217

(57) ABSTRACT

Provided is an operation method applicable to sender device having a screen and a currently opened file displayed on the screen. When the sender device identifies a user gesture matching a predefined send command, the sender device performing following steps: (1) setting the currently opened file as a to-be-sent file when the sender device knows a file name of the currently opened file; otherwise capturing a current screen display on the screen as the to-be-sent file when the sender device does not know the file name of the currently opened file; (2) sending a sending request to a receiver device; and (3) sending the to-be-sent file to the receiver device when the sender device receives a response from the receiver device.

This application claims the benefit of Taiwan application Serial No. 100111660, filed Apr. 1, 2011, the subject matter of which is incorporated herein by reference.

### TECHNICAL FIELD

The disclosure relates in general to an operation method applicable to an electronic device having an operation system, the electronic device sending or sharing a file by identifying a user gesture.

### BACKGROUND

Computers (PC/NB) and electronic products (such as a digital camera) have gained great popularity and become indispensable to people's everydayness and business. When a file (such as a document or a graphic) needs to be verified and identified by two or more computer users jointly, the file are sent to the two or more users' computers, so that users can open and view the file.

Currently, sending/sharing of file between computers can be achieved through a physical storage device (such as USB flash drive) or e-mailing. However, in order to send or share a file through the physical storage device, the user who originally owns the file inserts the physical storage device to his computer. After the file is stored in the physical storage device, the physical storage device is removed from the computer and inserted to another users' computer, so that the other user can copy the file to his/her computer from the physical storage device. If the file is shared through e-mailing, then the user keys in the receiver's e-mail address and attaches the file in the e-mail.

The above methods for sharing file are troublesome. Non-computer electronic products, such as digital camera and smart phone, are subjected to more restrictions, and file sharing is more complicated. For example, the procedure for sharing file would become even more complicated or troublesome if the non-computer electronic products does not or cannot install an operation system with built-in e-mailing function or the popular physical storage devices may support a large variety of interfaces.

### SUMMARY OF THE DISCLOSURE

The disclosure is directed to an operation method applicable to an electronic device having an operation system, the electronic device automatically sending a file to a receiver device if it is identified that a user gesture matches a predefined send command.

According to one embodiment the present disclosure, provided is an operation method applicable to a sender device having a screen and a currently opened file displayed on the screen. When the sender device identifies a user gesture matching a predefined send command, the sender device performs: (1) setting the currently opened file as a to-be-sent file when the sender device knows a file name of the currently opened file; otherwise capturing a current screen display on the screen as the to-be-sent file when the sender device does not know the file name of the currently opened file; (2) sending a sending request to a receiver device; and (3) sending the to-be-sent file to the receiver device when the sender device receives a response from the receiver device.

According to an alternate embodiment the present disclosure, provided is a sender device having an operation system, a screen and a currently opened file displayed on the screen. When the sender device identifies that a user gesture matches a predefined send command, the sender device sets a currently opened file as a to-be-sent file when the sender device knows a file name of the currently opened file; otherwise the sender device captures a current screen display on the screen as the to-be-sent file when the sender device does not know the file name of the currently opened file. The sender device sends a sending request to a receiver device through a first connection. The sender device receives through the first connection from the receiver device, a response indicating whether the receiver device receives the to-be-sent file sent. The sender device sends the to-be-sent file from the sender device to the receiver device through a second connection different from the first connection.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a system diagram according to first and second embodiments of the present disclosure;

FIG. 2 shows a flowchart of sending file according to the first embodiment of the present disclosure;

FIG. 3A shows an executing software supporting a predefined interface according to the first embodiment of the present disclosure;

FIG. 3B shows an executing software not supporting the predefined interface according to the first embodiment of the present disclosure;

FIG. 4A and FIG. 4B are flowcharts of sending file according to the second embodiment of the present disclosure; and

FIG. 5 shows another use scenario according to the two embodiments of the present disclosure.

### DETAILED DESCRIPTION OF THE DISCLOSURE

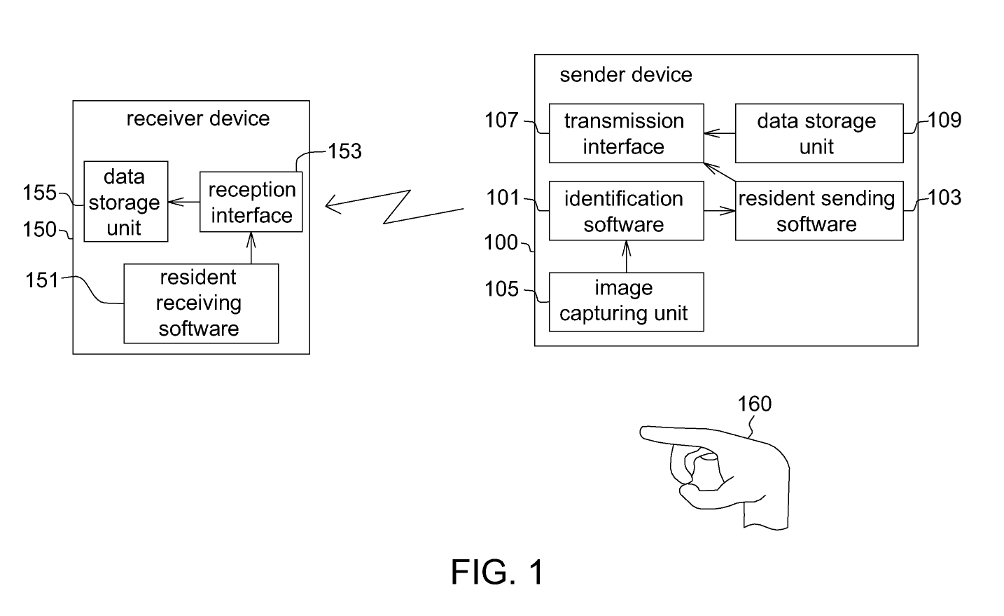

FIG. 1 shows a system diagram according to first and second embodiments of the present disclosure. As indicated in FIG. 1, the sender device 100 includes an identification software 101, a resident sending software 103, an image capturing unit 105, a transmission interface 107 and a data storage unit 109. The receiver device 150 includes a resident receiving software 151, a reception interface 153 and a data storage unit 155. The sender device 100 and the receiver device 150 may be realized by such as a personal computer, a notebook computer, a mobile phone, a digital camera, a digital video recorder, a smart phone, and so on. Basically, the sender device 100 and the receiver device 150 are both equipped with an operation system, and the variety of the operation system is not subjected to any particular restrictions here.

The image capturing unit 105 captures an external image, and sends the external image to the identification software 101 for identification. The identification software 101 sends an identification result to the resident sending software 103.

The resident sending software 103 is resident in the sender device 100. In the present disclosure, if a user gesture 160 (which is an external image) identified by the identification software 101 conforms to a default gesture related to a sending command, then the resident sending software 103 automatically sends the file to the receiver device 150. Exemplarily but not restrictively, after the user gesture 160 is identified by the identification software 101 as a leftward gesture, the identification software 101 determines that this gesture indicates that the user decides to send the file to the receiver device 150 positioned at left. Then, the resident sending software 103 tries to send the file to the receiver device 150 positioned at left. The details are disclosed below.

The resident receiving software 151 of the receiver device 150 detects a sending request sent from the resident sending software 103 of the sender device 100 and determines subsequent operations. The details of the operations are disclosed below.

Methods for sending files are respectively disclosed in two embodiments of the present disclosure below.

### First Embodiment

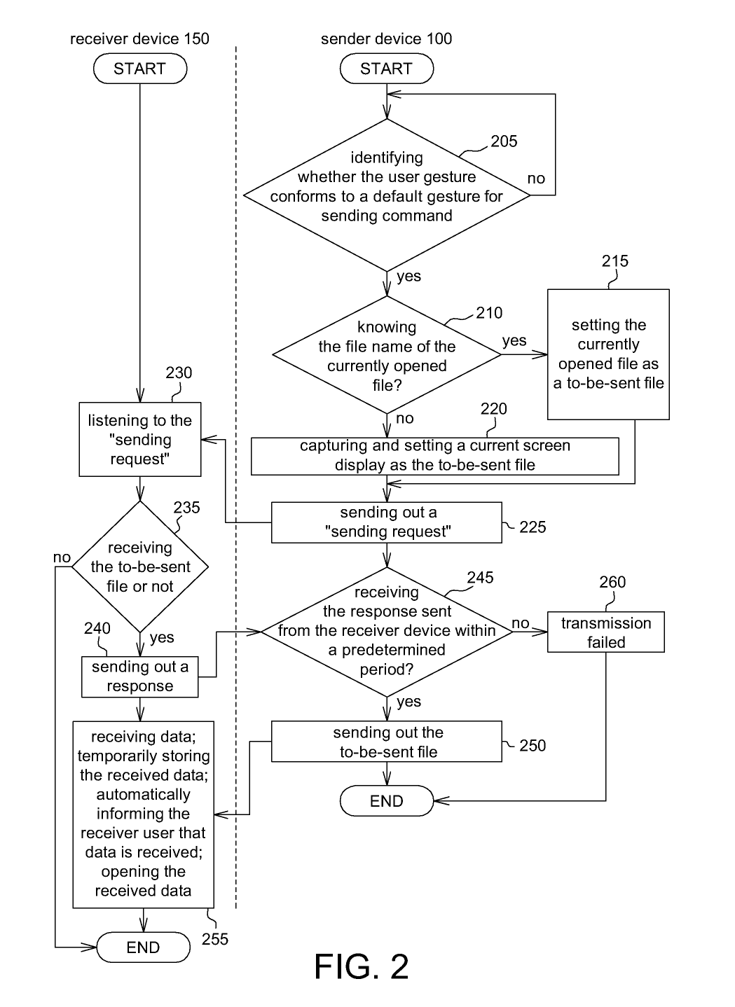

Referring to FIG. 2, a flowchart of sending file according to a first embodiment of the present disclosure is shown. As indicated in FIG. 2, in step 205, the sender device 100 identifies whether the user gesture conforms to the default gesture for sending command via the image capturing unit 105 and the identification software 101. If so, then the resident sending software 103 of the sender device 100 tries to get the file name of the currently opened file as indicated in step 210. For example, the resident sending software 103 inquires the operation system of the sender device 100 to know the currently executing software to further know the file name of the currently opened file.

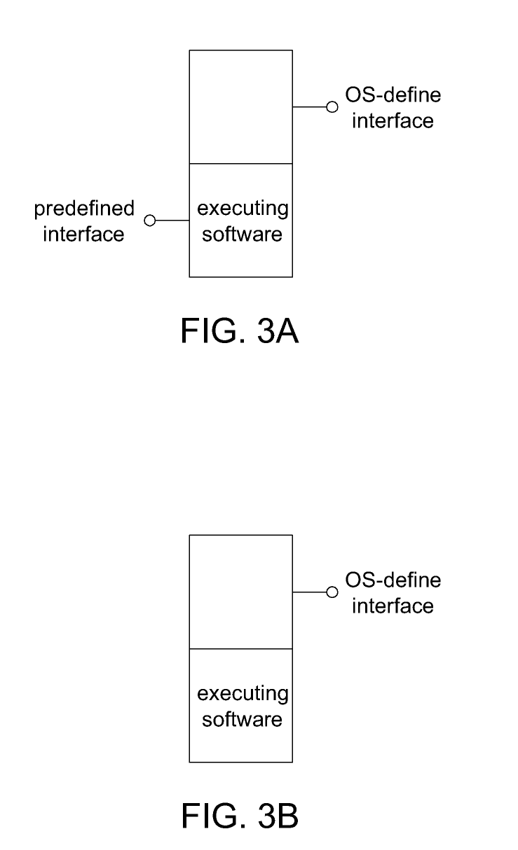

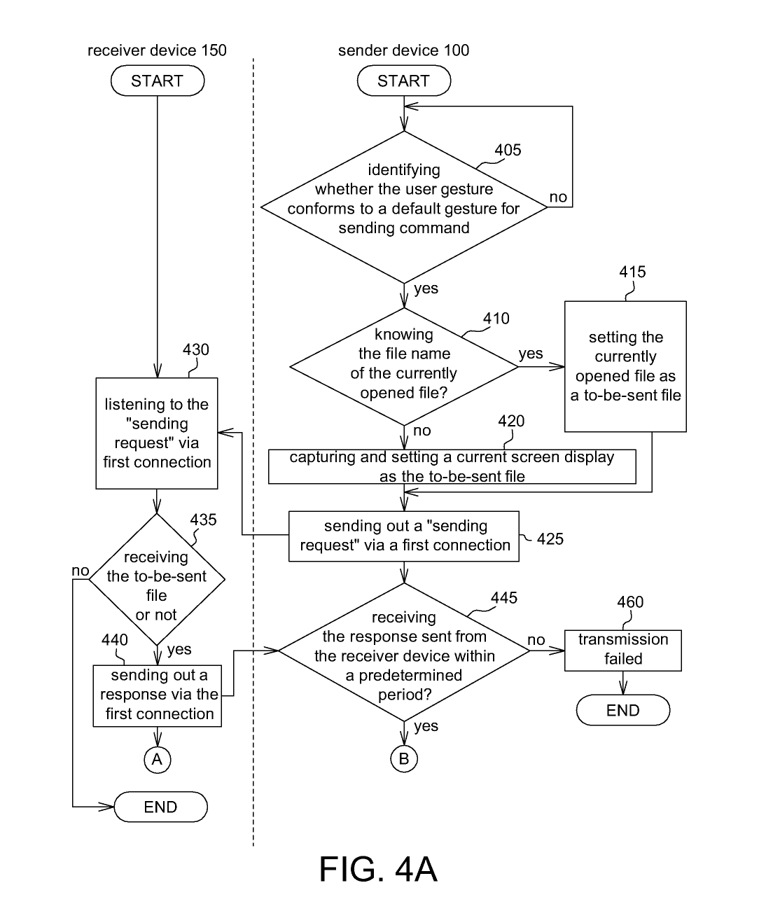

If the executing software supports a predefined interface (as indicated in FIG. 3A), this implies that the resident sending software 103 knows the file name, the format, and the storage position of the currently opened file through the currently executing software and sets the currently opened file as a to-be-sent file as indicated in step 215.

For example, suppose the sending end user opens an e-mail ABC.msg by an e-mail software (such as outlook or outlook express). If the resident sending software 103 knows from the currently executing e-mail software that the file has a file name ABC and has a file format .msg, and is stored in directory X of the data storage unit 109, then the resident sending software 103 sets the e-mail as the to-be-sent file.

Or, suppose the sending end user opens an attachment file DEF.doc of an e-mail by office software (such as Word). If the resident sending software 103 knows from the currently executing word office software “Word” that the file name of the attachment file of the e-mail is DEF, the file format is word document (.doc), and the attachment file is stored in directory Y of the data storage unit 109, then the resident sending software 103 sets the word document file as the to-be-sent file.

Also, the predefined interface supported by the currently executing software of the sender device 100 may be further expanded so that the resident sending software 103 of the sender device 100 may collect (1) meta data of the currently opened file or (2) other attached data of the sender device 100, to send to the receiver device 150. Examples of meta data include file name, file writer, file size, and so on. Examples of the attached data of the sender device 100 include the file sender's contact (such as the mobile phone number of the owner of the sender device 100) and the file sender name (such as the user name of the sender device 100).

If the receiver has failed in receiving the file, then the receiver user may contact the file owner or the file sender to resend the file.

If the receiver user does not want to receive the file after seeing the file name or the sender name, the receiver user may refuse to receive the file to avoid unnecessary data transmission.

To the contrary, if the currently executing software does not support the predefined interface (as indicated in FIG. 3B), that is, the resident sending software 103 does not know the file name of the currently opened file through the currently executing software, then the resident sending software 103 captures the screen display and sets the captured screen display as the to-be-sent file as indicated in step 220. For example, the resident sending software 103 may call the operation system (OS) define interface (such as Windows API Capture Screen written by C language) to capture the current screen display.

After setting the to-be-sent file, the resident sending software 103 sends out a “sending request” to the resident receiving software 151 of the receiver device 150 through a connection established between the transmission interface 107 and the reception interface 153 as indicated in step 225.

In step 230, the resident receiving software 151 of the receiver device 150 detects/listens to determine whether the “sending request” sent from the resident sending software 103 of the sender device 100 is received.

Once detecting the “sending request”, the resident receiving software 151 of the receiver device 150 decides whether to receive the to-be-sent file from the resident sending software 103 of the sender device 100 as indicated in step 235. For example, the resident receiving software 151 of the receiver device 150 decides whether to receive the to-be-sent file from the resident sending software 103 of the sender device 100 according to a default value or a user setting.

For example, once receiving the “sending request”, the resident receiving software 151 of the receiver device 150 inquires the receiver user and after the receiver user sees the file name or the sender name, the receiver user decides whether to send a response for start receiving the file.

Or, the receiver user may pre-set in the resident receiving software 151 of the receiver device 150 that (1) the receiver device 150 sends the response to start receiving the file if the file sender name is on the “authorized user” list; or (2) the receiver device 150 does not send the response for preventing the file receiving procedure from staring if file sender name is on the “non-authorized user” list.

In step 240, if the resident receiving software 151 of the receiver device 150 decides to receive the to-be-sent file, then the resident receiving software 151 of the receiver device 150 sends a response to the resident sending software 103 of the sender device 100 through the connection between the transmission interface 107 and the reception interface 153.

After sending the sending request, the resident sending software 103 of the sender device 100 counts and determines whether a response sent from the resident receiving software 151 of the receiver device 150 is received within a predetermined period as indicated in step 245. If the response is not received after the predetermined period, then the resident sending software 103 of the sender device 100 determines that transmission is failed as indicated in step 260.

If the resident sending software 103 of the sender device 100 receives the response from the resident receiving software 151 of the receiver device 150 within the predetermined period, then the resident sending software 103 of the sender device 100 sends the to-be-sent file to the resident receiving software 151 of the receiver device 150 through the connection as indicated in step 250.

In step 255, the resident receiving software 151 of the receiver device 150 receives data (i.e. the to-be-sent file sent from the resident sending software 103 of the sender device 100), and temporarily stores the received data to the data storage unit 155. After completion of data receiving, the resident receiving software 151 of the receiver device 150 may automatically inform the receiver user that the data receiving is completed. In addition, the resident receiving software 151 of the receiver device 150 may further automatically inquire the receiver user to open or store the received data.

According to the above elaboration, in the present disclosure embodiment, when the sending end user decides to send data (such as the file currently being opened or the screen display) to the receiver, the sending end user sends data to the receiver device 150 from the data storage unit 109 of the sender device 100 with a default gesture (such as a leftward or a rightward gesture), and the receiver device 150 temporarily stores the received data in the storage unit 155. Thus, data sending or data sharing is made much more convenient.

### Second Embodiment

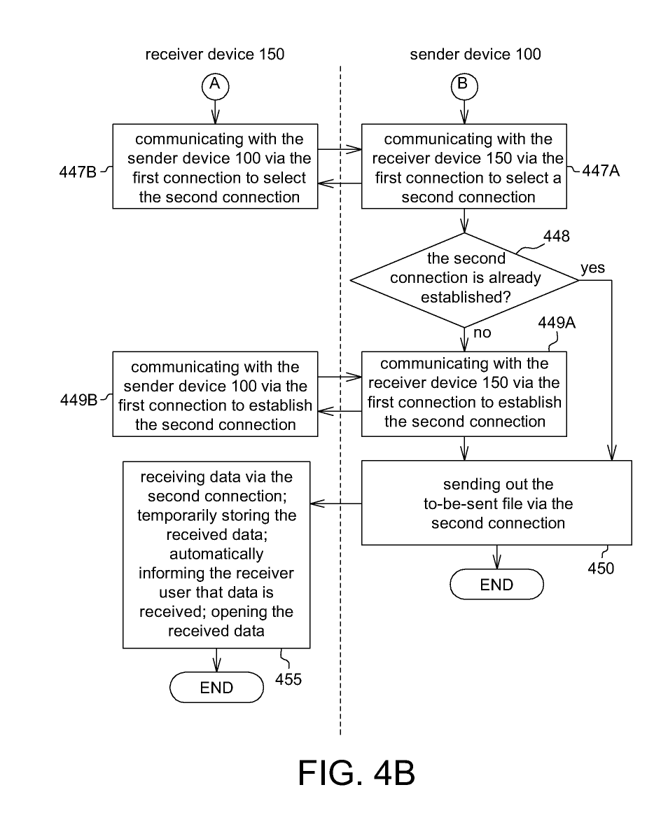

Referring to FIG. 4A and FIG. 4B, flowcharts of sending file according to a second embodiment of the present disclosure are shown. Steps 405˜420 are basically the same or similar with that of steps 205˜220 of FIG. 2, and the similarities are not repeated here.

After setting the to-be-sent file, the resident sending software 103 sends a “sending request” to the resident receiving software 151 of the receiver device 150 through a first connection established between the transmission interface 107 and the reception interface 153 as indicated in step 425.

Here, the first connection such as refers to a general-definition communication including connection for initialization communication between two devices. There is a communication channel between the sender device 100 and the receiver device 150, such as message broadcasting (from the sender device) and message receiving (by the receiver device). Here, data transmission may achieve the “general-definition communication” by applicable ways such as infrared, Bluetooth, Wi-Fi.

For example, “the first connection”, such as a connection already established between the sender device 100 and the receiver device 150, may be realized by connections applicable for initialization communication between the sender device 100 and the receiver device 150.

In step 430, the resident receiving software 151 of the receiver device 150 detects the “sending request” sent from the resident sending software 103 of the sender device 100 through the first connection. The details of step 430 are the same or similar with that of step 230 of the first embodiment, and the details are omitted here.

On detecting the “sending request” sent from the sender device 100 through the first connection, the resident receiving software 151 of the receiver device 150 decides whether to receive the to-be-sent file from the resident sending software 103 of the sender device 100 as indicated in step 435. The details of step 435 are the same or similar with that of step 235 of the first embodiment, and the details are omitted here.

In step 440, if the resident receiving software 151 of the receiver device 150 decides to receive the file, then the resident receiving software 151 of the receiver device 150 sends a response to the resident sending software 103 of the sender device 100 through the first connection. The details of step 440 are the same or similar with that of step 240 of the first embodiment, and the details are omitted here.

After sending the sending request, the resident sending software 103 of the sender device 100 counts and determines whether the response sent from the resident receiving software 151 of the receiver device 150 is received within a predetermined period as indicated in step 445. The details of step 445 are the same or similar with that of step 245 of the first embodiment, and the details are omitted here.

If the response is not received after the predetermined period, then the resident sending software 103 of the sender device 100 determines that transmission is failed as indicated in step 460.

If the resident sending software 103 of the sender device 100 receives the response from the resident receiving software 151 of the receiver device 150 through the first connection within the predetermined period, then the resident sending software 103 of the sender device 100 and the resident receiving software 151 of the receiver device 150 communicate with each other through the first connection to select a second connection as indicated in steps 447A and 447B.

Here, the second connection refers to a narrow-definition connection which may be a file transmission connection after initialization, and may be realized by such as point to point transmission, Internet transmission (either wire or wireless), Wi-Fi, 3.5G, and so on.

For example, after communication between the sender device 100 and the receiver device 150, “the second connection” may be realized by the first connection which is already established or a new connection established by the sender device 100 and the receiver device 150.

In other possible implementations, in communication between the sender device 100 and the receiver device 150 about choose of the second connection, if it is evaluated that time for sending data through the existing connection (such as the first connection) is smaller than a threshold, then the existing connection (such as the first connection) is used as the second connection for sending data. To the contrary, if it is evaluated that the required time for sending data through the existing connection (such as the first connection) is larger than the threshold, then the sender device 100 and the receiver device 150 may establish any high-speed connection as the second connection for sending data.

In other possible implementations, after the sender device 100 and the receiver device 150 communicate with each other, they may know which transmission interfaces are supported by them, and the transmission interface having enough or highest data rate may be selected as the second connection.

In step 448, after the resident sending software 103 of the sender device 100 and the resident receiving software 151 of the receiver device 150 select the second connection, the two devices determine whether the second connection is already established between the sender device 100 and the receiver device 150.

If the second connection is not established, then the resident sending software 103 of the sender device 100 and the resident receiving software 151 of the receiver device 150 communicate with each other through the first connection to establish the second connection, even without user instruction, as indicated in steps 449A and 449B.

After that the second connection is already established between the two aforementioned devices, the resident sending software 103 of the sender device 100 sends the to-be-sent file to the resident receiving software 151 of the receiver device 150 through the second connection as indicated in step 450. The details of step 450 are the same or similar with that of step 250 of the first embodiment, and the details are omitted here.

In step 455, the resident receiving software 151 of the receiver device 150 receives data (i.e. the to-be-sent file sent from the resident sending software 103 of the sender device 100) through the second connection, and temporarily stores the received data to the data storage unit 155. On completion of data receiving, the resident receiving software 151 of the receiver device 150 may automatically inform the receiver user that the data receiving is completed. In addition, the resident receiving software 151 of the receiver device 150 may further automatically inquire the receiver user whether to open the received data or to store the received data.

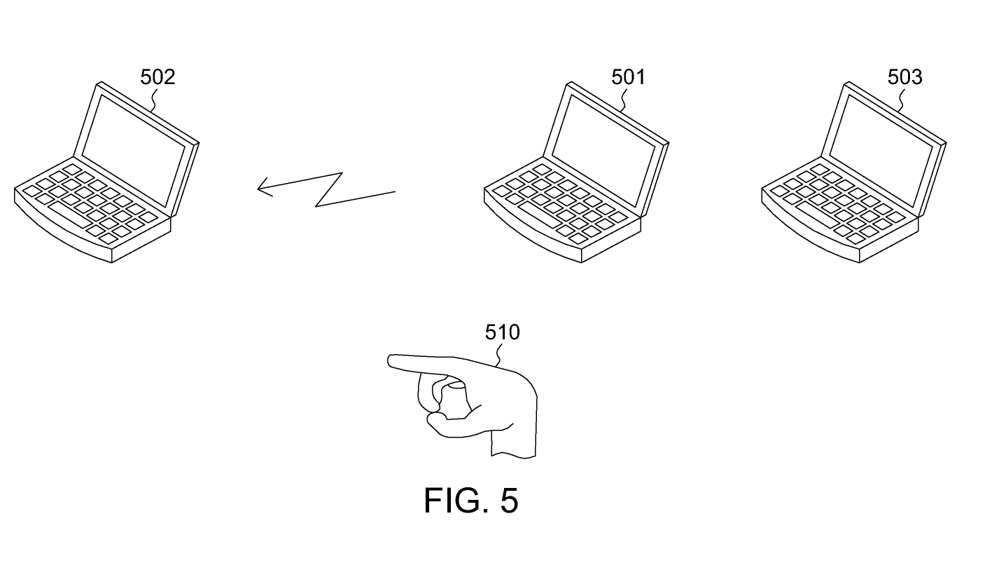

FIG. 5 shows another use scenario according to two embodiments of the present disclosure. As indicated in FIG. 5, the sender device 501 and the receiver devices 502 and 503 are equipped with positioning devices (such as GPS). By sending current geographic position to each other, the sender device 501 determines that the receiver device 502 is positioned at left and the receiver device 503 is positioned at right.

The setting may be as follows. If the user gesture is directed to left, this indicates that the sender device 501 tries to send the file to the receiver device 502 positioned at left. To the contrary, if the user gesture is directed to right, this indicates that the sender device 501 tries to send the file the receiver device 503 positioned at right.

If the sender device 501 identifies that the user gesture 510 conforms to the default gesture, then the sender device 501 tries to send the file to the receiver device 502 positioned at left. In the example of FIG. 5, the user gesture 510 is directed to left In the present embodiment of the disclosure, if a computer system is equipped with both the resident sending software and the resident receiving software, then this computer system possesses both the sender function and the receiver function of FIG. 1. Suppose several (such as 2) computer systems possess both the sender function and the receiver function. The user of the first computer system sends a file to the second computer system according to the above method with a default gesture (such as a leftward gesture). If the second computer system receives the file and further processes the received file (such as editing), then the user of the second computer system may send the file back to the first computer system according to the above method with a default gesture (such as a rightward gesture).

The application of disclosure is not limited to the above scenario. In a classroom, a teacher may send a file (such as a test sheet) to students according to the above method with a default gesture (such as a leftward gesture). After receiving the test sheet, the students may process the file (such as writing the test sheet), and send the file back to the teacher according to the above method with a default gesture (such as a rightward gesture).

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. An operation method applicable to a sender device having a screen and a currently opened file displayed on the screen, the method comprising steps of:
when the sender device identifies a user gesture matching a predefined send command, the sender device performing following steps:
(1) setting the currently opened file as a to-be-sent file when the sender device knows a file name of the currently opened file; otherwise capturing a current screen display on the screen as the to-be-sent file when the sender device does not know the file name of the currently opened file;
(2) sending a sending request to a receiver device; and
(3) sending the to-be-sent file to the receiver device when the sender device receives a response from the receiver device.

2. The method according to claim 1, wherein the sender device further comprising:
a resident sending software capable to communicate with an operation system of the sender device to know a currently executing software displaying the currently opened file on the screen;
when the currently executing software supports a predefined interface, the resident sending software receives the file name of the currently opened file from the currently executing software through the predefined interface; and
when the currently executing software does not support the predefined interface, the resident sending software captures the current screen display.

3. The method according to claim 2, wherein,
in case that the currently executing software is an e-mail software supporting the predefined interface,
(i) when the currently opened file is an e-mail, then the sender device sets the e-mail as the to-be-sent file; or
(ii) when the currently opened file is an attachment of the e-mail, then the sender device sets the attachment of the e-mail as the to-be-sent file.

4. The method according to claim 1, wherein,
the sender device sends the sending request to the receiver device through a first connection;
the sender device receives the response from the receiver device through the first connection when the receiver device decides to receive the to-be-sent file; and
the sender device sends the to-be-sent file to the receiver device through the first connection;
the first connection is used for message broadcasting or initialization communication between the sender device and the receiver.

5. The method according to claim 1, wherein,
the sender device sends the sending request to the receiver device through a first connection;
the receiver device receives the response from the receiver device through the first connection when the receiver device decides to receive the to-be-sent file;
after the sender device receives the response sent from the receiver device through the first connection, the receiver device and the sender device communicate through the first connection and select a second connection; and
if the sender device and the receiver device have not yet established the second connection, then the sender device and the receiver device automatically establish the second connection.

6. The method according to claim 5, wherein,
the first connection comprises any connections used for message broadcasting and messages receiving or any connections used for initialization communication between the sender device and the receiver;
the second connection comprises any data transmission connections, any existing connections between the sender device and the receiver device after the sender device communicates with the receiver device, or any newly-established connections between the sender device and the receiver device.

7. The method according to claim 5, wherein,
after the sender device communicates with the receiver device,
(i) an existing connection between the sender device and the receiver device is used as the second connection if it is evaluated that a required data transmission time via the existing connection is shorter than a threshold, or,
(ii) a newly-established connection is established as the second connection if it is evaluated that the required data transmission time via the existing connection is longer than the threshold.

8. The method according to claim 5, wherein,
after the sender device communicates with the receiver device, a transmission interface evaluated having a shortest required data transmission time is selected from a plurality of transmission interfaces supported by both devices as the second connection.

9. The method according to claim 1, wherein, when the sender device knows the file name of the currently opened file, the sender device further adds a meta data of the currently opened file into the to-be-sent file for being sent to the receiver device.

10. The method according to claim 1, further comprising:
sending the to-be-sent file to the receiver device positioned on the right side of the sender device if the sender device knows that the receiver device is positioned at right of the sender device and determines that the user gesture indicates sending the to-be-sent file toward right direction.

11. An operation method applicable to a sender device having an operation system, a screen and a currently opened file displayed on the screen, the method comprising steps of:
when the sender device identifies that a user gesture matches a predefined send command, setting a currently opened file as a to-be-sent file by the sender device when the sender device knows a file name of the currently opened file; otherwise capturing a current screen display on the screen as the to-be-sent file by the sender device when the sender device does not know the file name of the currently opened file;
sending a sending request to a receiver device through a first connection by the sender device;
receiving through the first connection from the receiver device, a response indicating whether the receiver device receives the to-be-sent file sent; and
sending the to-be-sent file from the sender device to the receiver device through a second connection different from the first connection.

12. The method according to claim 11, wherein,
a resident sending software capable to communicate with an operation system of the sender device to know a currently executing software displaying the currently opened file on the screen;
the resident sending software knows the file name of the currently opened file from the currently executing software if the currently executing software supports a predefined interface; and
the resident sending software captures the current screen display if the currently executing software does not support the predefined interface.

13. The method according to claim 12, wherein,
if the currently executing software is an e-mail software supporting the predefined interface,
(i) when the currently opened file is an e-mail, the sender device sets the e-mail as the to-be-sent file; or
(ii) when the currently opened file is an attachment of the e-mail, the sender device sets the attachment of the e-mail as the to-be-sent file.

14. The method according to claim 11, wherein,
after the sender device receives the response from the receiver device through the first connection, the sender device communicates with the receiver device through the first connection and selects the second connection; and
if the sender device and the receiver device have not yet established the second connection, then the sender device and the receiver device automatically establish the second connection.

15. The method according to claim 11, wherein, if the sender device knows the file name of the currently opened file, the sender device further adds a meta data of the currently opened file into the to-be-sent file for being sent to the receiver device.

16. The method according to claim 11, wherein,
the sender device and the receiver device each has a positioning device; and
the sender device sends the to-be-sent file to the receiver device positioned on the right side of the sender device if the sender device knows that the receiver device is positioned at right of the sender device and determines that the user gesture indicates sending the to-be-sent file toward right direction.

17. The method according to claim 11, wherein,
when the sender device communicates with the receiver device,
(i) an existing connection between the sender device and the receiver device is used as the second connection if it is evaluated that a required data transmission time via the existing connection is shorter than a threshold, or,
(ii) a newly-established connection is established as the second connection if it is evaluated that the required data transmission time via any existing connection is longer than the threshold.

18. The method according to claim 11, wherein,
after the sender device communicates with the receiver device, a transmission interface evaluated having a shortest data transmission time is selected from a plurality of transmission interfaces supported by both sender and receiver devices as the second connection.
